(19) United States
(12) Patent Application Publication
(10) Pub. No.: US 2004/0091401 A1
(43) Pub. Date: May 13, 2004

(54) Self-aligning blood collection tube with encoded information

(76) Inventors: Robert S. Golabek JR., Towaco, NJ (US); Hugh T. Conway, Verona, NJ (US)

Correspondence Address: David W. Highet, Esq., Becton, Dickinson and Company, 1 Becton Drive, Franklin Lakes, NJ, 07417, US

(21) Appl. No.: 10/608,175

(22) Filed: Jun. 27, 2003

Related U.S. Application Data
(62) Division of application No. 09/542,494, filed on Apr. 3, 2000, now abandoned.

(51) Int. Cl. B01L 3/14

(52) U.S. Cl. 422/102; 422/104; 422/99; 235/449; 235/454; 235/462.01; 235/462.02

(57) ABSTRACT

A tube is provided for biological fluids that includes a closed bottom, an open top and a cylindrical sidewall extending therebetween. An alignment key is formed at a selected circumferential position on the tube. An array of machine-readable information is provided on the tube at a specified angular position relative to the alignment key. The alignment key functions to position the tube in a laboratory apparatus at a rotational position that will ensure proper alignment between the array of information and a portion of the apparatus that is operative to read the array of information. The array of information may be in the form of a magnetic strip or optically readable information such as a bar code.

### BACKGROUND OF THE INVENTION

1. Field of the Invention

The present invention relates to a blood collection tube having a self-aligning feature and a region for storing optically or magnetically encoded information.

2. Description of Related Art

Biological specimens, such as blood, are collected in test tubes and transported to a laboratory for analysis. The laboratory performs the required tests and presents the tests in a report that is sent to the health care provider. Care must be taken to ensure that the test results are properly matched to the patient. As a result, the health care provider labels the test tubes of blood with accurate patient identification information, as well as information to identify health care provider and the tests that need to be performed. The health care provider typically will prepare a plurality of labels that identify both the provider and the patient. The labels may be reviewed with the patient to ensure that relevant material has been properly presented. The health care provider then may apply the labels to the respective test tubes. Information to identify the required tests may be imprinted on the labels or may be indicated by color coding on the tube, or on the tube cap.

Laboratories also must take care to ensure that the test results are matched with the proper patient. Most laboratory tests are performed by highly automated machines. However, many laboratories require manual activities to ensure proper cross-referencing of test results to the patient. These manual activities reduce efficiency and create the potential for human error.

Some automated machines have a reader for reading indicia. The indicia and the readers can take many forms, including optical readers, such as bar code readers, or magnetically encoded readers for reading digital information encoded on a magnetic stripe. The reader is typically well suited for reading indicia that has been placed on a planar object that passes in proximity to the reader. Arcuate objects, such as a cylindrical blood collection tube, are not well suited to the automated reading of encoded information. In particular, the arcuate object must be rotated into an orientation where the information is properly aligned with the reader. An improper alignment may cause an improper reading of the information. As a result, systems to read information on a cylindrical or round object may require a manual task of rotating the cylindrical or round object into a proper orientation to be read by the reader. This need for manual orientation significantly reduces the speed and efficiency of analytical test equipment and creates the potential for human error.

Accordingly, a need exists for providing alignment capabilities on a cylindrical or round object to reduce the need for manual orientation of the object in automated machines.

### SUMMARY OF THE INVENTION

The present invention is a tube for biological fluids, that may be unitarily molded from plastic and includes a closed tapered bottom wall, an open top and a cylindrical sidewall extending therebetween. A cap may be mounted to the open top of the tube for providing a seal across the open top. The tube includes an alignment key to enable a selected rotational orientation of the tube to be attained accurately and automatically. The alignment key preferably is positioned near the tapered bottom wall of the tube to avoid dimensional or configuration changes to the cylindrical sidewall of the tube. More particularly, the bottom end of the tube may be formed with a projection or indentation that is asymmetrical with respect to the longitudinal axis of the tube. For example, the alignment key may comprise a single fin disposed in a plane that passes through the longitudinal axis of the cylindrical sidewall and that projects outwardly from the tapered bottom wall of the tube. The fin may have a bottom edge that is orthogonal to the axis of the cylindrical sidewall and substantially tangent to the bottom wall of the tube. The fin may further include a side edge that is parallel to the axis of the tube and substantially collinear with the cylindrical sidewall of the tube.

Alternatively, the tapered bottom end of the tube may be substantially hemispherical, and the alignment key may define a planar flat formed on the hemispherical bottom wall of the tube. The flat may be aligned to intersect the longitudinal axis of the sidewall at an acute angle.

As a further alternate, the alignment key may comprise an indentation at a selected rotational position on the tube. For example, the indentation may include a first wall aligned along or parallel to the longitudinal axis of the tube and a second wall aligned at an acute or right angle to the longitudinal axis of the tube. The first and second walls of the indentation may intersect one another at a selected angle, such as a right angle.

The tube further includes a region for encoded information, such as optically or magnetically encoded information. The region for encoded information is provided at a selected rotational position on the tube relative to the alignment key. For example, the region for encoded information may be on a portion of the cylindrical sidewall of the tube that is diametrically opposite the alignment key. Alternatively, the area for encoded information may be at a predetermined angular offset about the longitudinal axis relative to the alignment key.

The tube may further include a label for applying specified encoded information. The label may be applied at the place of manufacture of the tube to ensure accurate positioning relative to the alignment key. The label may be adhesively applied and may be coated with a selected material to inhibit separation from the tube and to provide a smooth outer surface that avoids interference with packaging material or with laboratory equipment. The information encoded on the tube may merely be alphanumeric information to define a specific unique code. The code that is provided on the tube then may be correlated to a specific patient by the health care provider, to effectively become an identification number for that patient. Alternatively, the encoded information on the tube may be provided with a writable portion that will enable information to be added to the encoded region of the tube by the health care facility. Thus, for example, a magnetic strip on the tube may be encoded with information that identifies the specific patient, the health care provider for which the tests are being performed and/or the types of tests to be carried out at the laboratory.

The tube may be filled with blood or other biological fluid to be tested in the conventional manner. The tube then is transported to the laboratory for analysis. The tube is positioned in the laboratory equipment such that the alignment key engages an alignment structure on the laboratory equipment. Thus, complete nesting of the alignment key on the tube with the key or key way on the laboratory equipment ensures that the encoded information is properly positioned to be read efficiently and accurately by automated reading equipment on the laboratory apparatus whereby the information is read on the tube from a specified angular position relative to the alignment key. As a result, test reports can be automatically and accurately matched with the patient information on the tube and subsequently can be transmitted to the appropriate health care provider. An alignment of the tube that could lead to a misreading of indicia is substantially prevented by the proper mating of the alignment key with the key or keyway on the apparatus and by the preselected orientation of the alignment key with the encoded information on the tube.

### DESCRIPTION OF THE DRAWINGS

FIG. 1 is a side elevational view of the tube of the present invention.

FIG. 2 is a rear elevational view of the tube shown in FIG. 1.

FIG. 3 is a bottom plan view of the tube shown in FIGS. 1 and 2.

FIG. 4 is a side elevational view, partly in section, of an alternate embodiment of the tube of the present invention.

FIG. 5 is a rear elevational view of the tube shown in FIG. 4.

FIG. 6 is a side elevational view of an alternate embodiment of the tube of the present invention.

FIG. 7 is a rear elevational view of the tube shown in FIG. 6.

### DETAILED DESCRIPTION

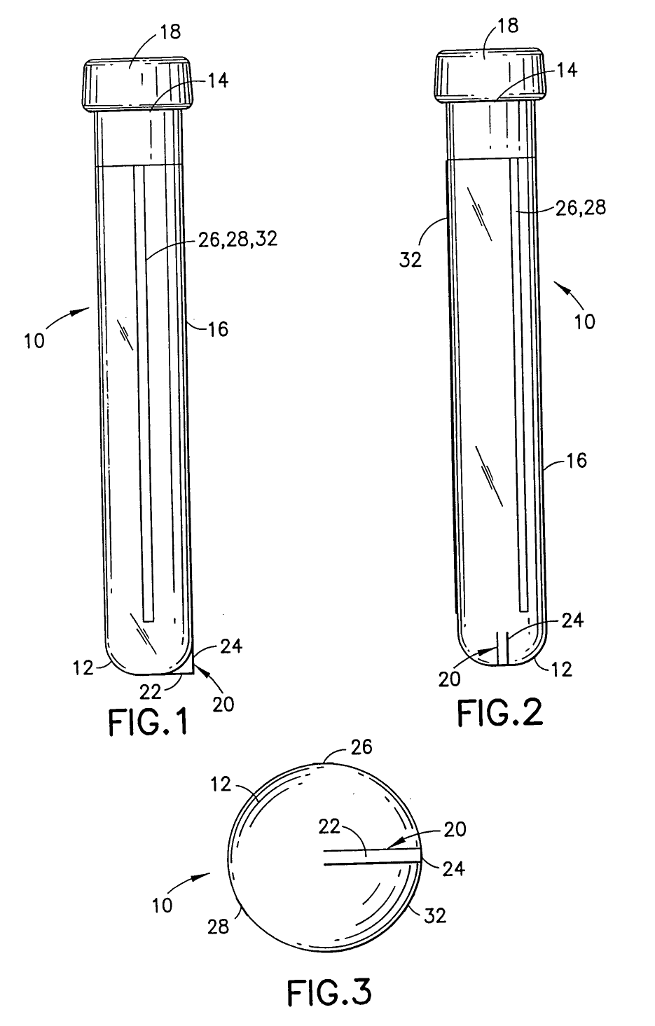

Referring to the drawings in which like reference characters refer to like parts throughout the several views thereof, FIGS. 1-3 illustrate a tube 10 with an alignment key 20. Tube 10 is unitarily molded from a thermoplastic material and includes a closed bottom 12, an open top 14 and a cylindrical sidewall 16 extending therebetween. A closure 18 is sealingly engaged with portions of sidewall 16 adjacent open top 14, such that a vacuum is defined within tube 10.

Closed bottom end 12 of tube 10 is substantially hemispherical, and hence conforms with the conventional shape required by many types of automated laboratory equipment that would be used to perform tests on blood or other biological samples in tube 10. However, bottom end 12 of tube 10 is provided with an alignment key 20.

Alignment key 20 is a substantially planar fin that lies in a plane passing through the longitudinal axis of cylindrical sidewall 16. Alignment key 20 includes a bottom edge 22 that is aligned substantially orthogonal to the longitudinal axis of cylindrical sidewall 16 and substantially tangent to the hemispherical bottom of tube 10. The fin of alignment key 20 further includes a side edge 24 aligned substantially parallel to the longitudinal axis of cylindrical sidewall 16 and substantially collinear with a portion of cylindrical sidewall 16. Thus, bottom edge 22 and side edge 24 of alignment key 20 are substantially orthogonal to one another.

Tube 10 further includes an array of readable information 26 on a selected portion of sidewall 16 that is at a specified rotational orientation with respect to alignment key 20. As shown in FIG. 1, array 26 of information extends longitudinally along cylindrical sidewall 16 at a location spaced 90° from alignment key 20. Array 26 of information may be a magnetic stripe printed directly on the plastic material of tube 10.

Alternatively, array 26 of information may be provided initially on a label which then is adhered to cylindrical sidewall 16. Information presented on the label may be magnetically encoded information or optically encoded information. For example, optically encoded information may include a bar code that is readable by an optical scanner. The bar code may be of any type such as a linear bar code or a two dimensional dot matrix maxicode. The label may further include color-coded indicia, such as a color stripe. Color coded indicia on a label can avoid the need to employ a plurality of color-coded caps or closures, thereby simplifying inventory requirements.

Tube 10 can be used to collect a sample of a biological fluid such as blood for analysis. Tube 10 then is transported to a laboratory for analysis.

The laboratory equipment has a keyway dimensioned and disposed to receive alignment key 20. Engagement of alignment key 20 in the correspondingly configured key way of the laboratory equipment will ensure proper positioning and alignment of array 26 of information to be read by a magnetic reader or optical reader associated with the laboratory equipment for reading information on tube 10. The information read from array 26 will positively identify the patient from whom the blood sample was collected, the health care facility to which test results are to be directed and types of test to be carried out.

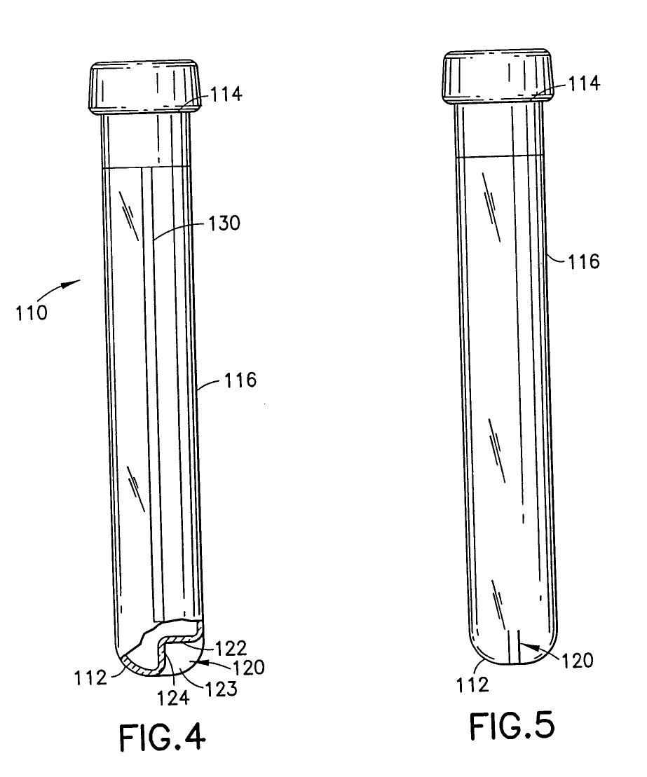

An alternate embodiment of the present invention is illustrated in FIGS. 4 and 5. Tube 110 is unitarily molded from a thermoplastic material and includes a hemispherical bottom wall 112, an open top 114 and a cylindrical sidewall 116 extending therebetween. An alignment key 120 extends inwardly on hemispherical bottom wall 112. More particularly, alignment key 120 effectively defines a notch having a horizontally aligned base wall 122 extending substantially orthogonally to the longitudinal axis of cylindrical sidewall 116. The notch of alignment key 120 further includes a vertically aligned base wall extending substantially along the longitudinal axis of the cylindrical sidewall 116. Alignment key 120 further includes a pair of side walls 123 which are aligned parallel to the longitudinal axis of cylindrical side wall 116 and perpendicular to base walls 122 and 124 respectively.

Cylindrical sidewall 116 of tube 110 includes an array of information 130 at a selected rotational position relative to alignment key 120. As shown in FIGS. 4 and 5, array of information 130 is 90° offset from alignment key 120.

In use, a biological fluid sample such as blood is collected in tube 110 and transported to a laboratory. Laboratory equipment is provided with a projection dimensioned and disposed to mate with alignment key 120. A nesting of the projection on the laboratory equipment with key 120 will ensure that array 130 of information aligns with a reader provided on the laboratory equipment. Array 130 of information may be disposed on sidewall 116 as described above with respect to test tube 10.

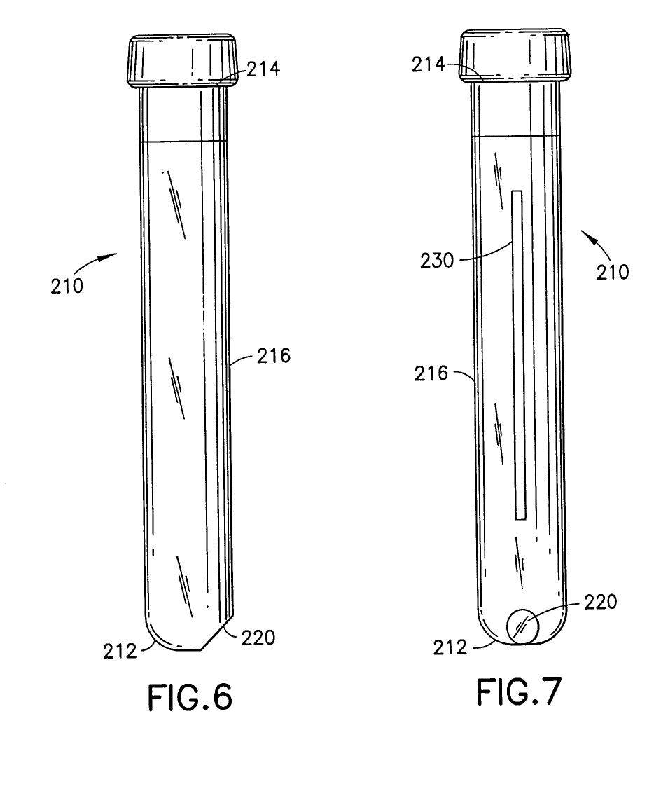

An alternate embodiment of the present invention is illustrated in FIGS. 6 and 7. Tube 210 includes a generally hemispherical bottom wall 212, an open top 214 and a cylindrical sidewall 216 extending therebetween. An alignment key 220 is formed on bottom wall 212 and defines a flat surface aligned at an acute angle to the axis of cylindrical sidewall 216. An array 230 of information is disposed along cylindrical sidewall 216 at a specified angular position relative to alignment key 220. In particular, as shown in FIGS. 6 and 7, alignment key 220 is offset from array 230 of information by 90°. Array 230 of information may take any of the forms described above with respect to tube 10. Additionally, tube 210 is used in precisely the manner of tubes 10 and 110 described above.

While the invention has been described with respect to several embodiments, it is apparent that various changes can be made without departing from the scope of the invention as defined by the appended claims. In particular, alignment keys of other shapes may be employed. Additionally, other machine-readable information may be provided on the tube at a specified rotational position relative to the alignment key. Additionally, the rotational position of the array of information and the alignment key can differ from the 90° offset illustrated in the figures. For example, a 180° offset or perfect alignment of (i.e., 0° offset) may be provided in accordance with the configuration of the laboratory equipment.

What is claimed is:

1. A tube having a closed bottom, a cylindrical side wall and an open top, said cylindrical side wall being concentric about a longitudinal axis, an array of information disposed on said cylindrical side wall and aligned substantially parallel to said longitudinal axis, an alignment key formed on said tube at a specified angular orientation relative to said array of information.

2. The tube of claim 1, wherein said alignment key is disposed substantially adjacent said bottom of said tube.

3. The tube of claim 2, wherein said bottom of said tube is substantially symmetrically tapered, said alignment key defining a non-symmetrical region at said bottom of said tube.

4. The tube of claim 3, wherein the alignment key defines a fin projecting outwardly from said tapered bottom.

5. The tube of claim 3, wherein the alignment key comprises a notch extending into said tapered bottom.

6. The tube of claim 3, wherein said alignment key defines a planar surface formed on said symmetrically tapered bottom of said tube.

7. The tube of claim 3, wherein said symmetrically tapered bottom of said tube is substantially hemispherical, said alignment key consisting of a planar fin lying in a plane passing through said longitudinal axis, said fin having a bottom edge substantially tangent to said hemispherical bottom and aligned substantially orthogonal to said longitudinal axis, said fin further comprising a side edge aligned with said cylindrical side wall of said tube and extending substantially parallel to said longitudinal axis.

8. The tube of claim 3, wherein said symmetrically tapered bottom wall of said tube is substantially hemispherical, said alignment key consisting of a planar surface interrupting said hemispherical bottom and aligned at an acute angle to said longitudinal axis.

9. The tube of claim 1, wherein said array of information comprises a magnetic stripe.

10. The tube of claim 1, wherein said array of information comprises an optically readable code.

11. The tube of claim 1, wherein said linear array of information is imprinted on a label, said label being secured to said cylindrical side wall of said tube.

12. The tube of claim 11, further comprising a coating applied over said label and over portions of said cylindrical side wall adjacent said label to provide a smooth exterior for said cylindrical side wall of said tube.

13. The tube of claim 1, wherein said tube is an evacuated blood collection tube further comprising a vacuum-sealed needle-pierceable closure secured to portions of said cylindrical side wall adjacent said open top.

14. A method for achieving accurate machine reading of information on a tube, said method comprising the steps of:
providing a tube having a closed bottom, an open top and a cylindrical side wall extending therebetween, said side wall being concentric about a longitudinal axis, said tube having an alignment key non-concentrically disposed relative to said longitudinal axis;
providing an array of information on said cylindrical side wall such that said array of information is substantially parallel to said longitudinal axis and such that said array of information is at a specified angular position relative to said alignment key;
collecting a sample of a biological fluid in said tube;
positioning said tube in a laboratory apparatus such that said alignment key engages an alignment structure on said laboratory apparatus; and
reading said information on said tube from a specified angular position relative to said alignment key.

15. The method of claim 14, wherein said alignment key is a substantially planar fin lying in a plane passing through said longitudinal axis, said method comprising the step of engaging said fin in a slot formed in said laboratory apparatus.

16. The method of claim 14, wherein said alignment key is a substantially planar notch extending into said evacuated blood collection tube, said laboratory apparatus comprising a planar fin, said method comprising the step of engaging said notch over said fin.

17. The method of claim 14, wherein said alignment key comprises a planar surface aligned at an acute angle to said longitudinal axis, said method comprising the step of positioning said planar surface of said evacuated blood collection tube against said planar surface on said laboratory apparatus.

18. The method of claim 14, wherein said array of information comprises a magnetic stripe, said step of reading said information comprising passing said evacuated blood collection tube in proximity to a magnetic reader for reading said information.

19. The method of claim 14, wherein said array of information comprises a bar code, said step of reading said information comprising optically scanning said code.

20. The method of claim 19, wherein said bar code is a linear bar code or a two dimensional dot matrix maxicode.
